(19) United States
(12) Patent Application Publication
(10) Pub. No.: US 2007/0085305 A1
(43) Pub. Date: Apr. 19, 2007

(54) Airbag module

(75) Inventors: Jens Feller, Illerkirchberg (DE); Michael Gross, Blaustein (DE)

Correspondence Address: FOLEY AND LARDNER LLP;SUITE 500, 3000 K STREET NW, WASHINGTON, DC, 20007, US

(73) Assignee: Takata-Petri AG

(21) Appl. No.: 11/545,062

(22) Filed: Oct. 10, 2006

(30) Foreign Application Priority Data
Oct. 10, 2005 (DE) 10 2005 049 218.5

(51) Int. Cl. B60R 21/217

(52) U.S. Cl. 280/728.2; 280/743.1

(57) ABSTRACT

An airbag for an airbag module of a motor vehicle, having an airbag sleeve which surrounds an interior of the airbag which is formed by at least two airbag parts which are connected to one another, and an insertion opening of the airbag sleeve through which an assembly of the airbag module which is to be arranged inside the airbag can be inserted into the interior of the airbag and which is formed by an interruption of the connection between the two airbag parts so that the two airbag parts each form one edge section of the insertion opening, and an assembly of the airbag module which is arranged in the interior of the airbag and can be inserted into the airbag through the insertion opening, in each case one clip protruding from each of the two edge sections of the insertion opening.

### BACKGROUND

The invention relates to an airbag module for a motor vehicle. Such a module includes an airbag that comprises an airbag sleeve which surrounds an interior of the airbag which can be filled with gas and which is formed by at least two airbag parts (airbag layers) (which rest one on the other in the noninflated state of the airbag) which are connected to one another along their circumferential outer edge, and an insertion opening of the airbag sleeve through which an assembly of the airbag module which can be arranged inside the airbag can be inserted into the interior of the airbag and which is formed by an interruption of the connection between the two airbag parts so that the two airbag parts each form one edge section of the insertion opening.

The assembly of the airbag module which is arranged in the interior of the airbag and can be inserted through the insertion opening can be a gas generator with which gas for inflating the airbag can be released or an airbag holder which is arranged inside the airbag in order to couple the airbag mechanically to a gas generator arranged outside the airbag or to a module housing of the airbag module, or some other dimensionally stable assembly which is arranged in the interior of the airbag in order to form an airbag module.

After the aforesaid assembly has been placed in the interior of the airbag, the insertion opening which is provided for this purpose has to be closed so that during possible later filling of the airbag with gas—in order to form an air cushion in the event of a crash—the gas which is provided for inflating the airbag is prevented from escaping early through the insertion opening or such a process is minimized. To do this it is known to cover the insertion opening with an additional fabric layer which is subsequently connected to the two airbag parts (preferably formed by one fabric part each). Therefore, an additional closure element as well as connecting means for connecting the closure element to the airbag sleeve are necessary to close the insertion opening for the assembly which is to be arranged inside the airbag. The closure element is formed in particular by two clips which each protrude from an edge section of the insertion opening.

### SUMMARY

There is a problem of providing an airbag for an airbag module which includes an easy to close insertion opening for an assembly which is to be arranged inside the airbag.

According to the above, the two clips are each formed from at least one flexible material section, the at least one material section of the one clip being embodied congruent with respect to the at least one material section of the other clip in a spread out flat state.

The respective clip is preferably placed around the assembly which is arranged inside the airbag in such a way that the respective clip engages at least partially around said assembly and the two clips overlap or cover one another in the process (at least along the insertion opening).

The two airbag parts are formed by at least one first fabric layer each, the at least one material section of the respective clip being preferably embodied in each case in one piece with a first fabric layer. In this case, the material section of a clip is preferably woven to the corresponding first fabric layer.

The two first fabric layers are preferably embodied in such a way that in a spread out flat (foldfree) state they have identically shaped contours, i.e. the two fabric layers are embodied so as to be congruent in said state.

In one variant of the invention, the airbag parts each have a second fabric layer which bears in each case in front of an inner side of a first fabric layer which faces the interior of the airbag sleeve. Such second fabric layers serve, inter alia, to reinforce the airbag sleeve, in particular in the region of the insertion opening or of the gas generator which is arranged at the insertion opening in the interior or the airbag sleeve. In this way it is possible, for example in the case of a hot gas generator, to reduce the risk of damage to the airbag sleeve due to the hot gases which are released when the airbag inflates by virtue of a two-layer formation of the airbag sleeve in the region of the gas generator. The second fabric layers are preferably embodied congruent with respect to one another in a spread out flat state.

Furthermore, the clip assigned to the respective airbag part preferably has a material region of the second fabric layers, the material section of each of the two clips being preferably folded in such a way that it engages around the material region of the second fabric layer of the respective clip, i.e. the material region of the second fabric layer forms an intermediate layer of the respective (three-layer) clip.

Thus, sections of the material section which are arranged on each side of the material region of the second fabric layer are formed and are secured to the material region of the second fabric layer by means of a seam as a result of the folding of the material section of a respective clip. The seam preferably extends along the insertion opening, i.e. along the respective edge section.

In one exemplary embodiment of the invention, the two clips are arranged and embodied mirror symmetrical so as to be to one another in a spread out flat state of the airbag sleeve.

In the solution according to the invention, the insertion opening lies between at least two airbag parts or airbag layers, in particular in the form of fabric layers, the extent of the opening being limited by the fact that regions of the airbag sleeve in which the two airbag parts are connected to one another along their outer edge adjoin the opening in each case. Suitable connecting means for connecting the airbag parts are, for example, seams, bonding agents, rivets or the like. In other words, the insertion opening is formed by an interruption in the connection between the two airbag parts so that the insertion opening is limited by one edge section each of the two airbag parts.

At the corresponding edge section, each of the two airbag parts has a clip which protrudes from the edge of the corresponding airbag part and which can be placed around the assembly which is to be inserted through the insertion opening into the interior of the airbag and arranged there, in such a way that the two clips overlap one another, at least one of the clips being connected to the assembly which is arranged inside the airbag.

Accordingly, in the solution according to the invention, the insertion opening of the airbag is not closed by a separate, additional fabric part but rather instead by clips which are provided directly on the airbag parts which form the airbag sleeve and are preferably embodied in one piece with these airbag parts.

Such a closed insertion opening of an airbag gives rise to minimum pressure losses in the region of the insertion opening when the airbag inflates, and permits the same airbag type to be used both for driver airbags and front seat passenger airbags.

The two clips are preferably placed at least partially around the assembly which is arranged inside the airbag in opposite directions, in such a way that in the overlapping region of the two clips the one clip at least partially covers the other clip so that this other clip extends between the one clip and the aforesaid assembly. In this case, at least the one, outer clip is advantageously secured to the assembly so that as a result the other, inner clip is simultaneously held between the assembly and the outer clip.

The arrangement and embodiment of the two clips are preferably such that in order to close the insertion opening one clip covers the insertion opening on the outside of the airbag sleeve facing away from the interior of the airbag and the other clips led into the interior of the airbag through the insertion opening where it extends on the inside of the airbag sleeve, in front of the insertion opening.

In order to secure at least one of the clips to the assembly which is arranged inside the airbag, a mounting element which protrudes from this assembly and which engages through a mounting opening in said clip is preferably provided. The mounting element may be, for example, a mounting bolt, and at the free end facing away from the assembly advantageously has a widened portion with which it can engage behind the edge of the assigned mounting opening of the corresponding clip. According to one advantageous embodiment of the invention, one of the two clips (advantageously the clip which is at the top in the overlapping region) is secured to the assembly which is arranged inside the airbag, while the airbag part on which the other of the two clips is provided (which clip lies in the overlapping region between the one clip and the assembly), is secured to said assembly outside said other clip, for example in turn by means of a mounting bolt which protrudes from the assembly and engages in a mounting opening of said airbag part. In this context, one and the same mounting elements of the assembly which is arranged inside the airbag preferably serve both to secure the one clip and to secure the airbag part on which the other clip is arranged.

Each of the two clips advantageously extends along the entire edge section of the associated airbag part so that essentially the entire edge of the insertion opening is bounded by the two clips and the two clips which overlap one another close the insertion opening. However, in this context, a small passage can be left free for connecting cable, for example in order to be able to supply an assembly in the form of a gas generator which is arranged inside the airbag and has the purpose of triggering it with electric current.

According to another embodiment of the invention, the insertion opening is only partially closed off by the clips which overlap one another so that a partial opening remains free, through which the assembly, for example a gas generator arranged inside the airbag, can project with one section out of the interior of the airbag. This permits, for example, electric contact to be made with a gas generator outside the airbag.

The two edge sections of the insertion opening are preferably arranged opposite one another and can also be of mirror symmetrical configuration here. The respective clip can, in one instance, be formed here in one piece integrally with the associated airbag part, that is to say form a uniform fabric layer in particular with an airbag part in the form of a fabric part. According to another embodiment of the invention, the two clips are formed by separate parts which are secured to the respectively assigned airbag part, for example by sewing or in some other way.

The at least two airbag parts which form the sleeve of the airbag which is provided with the insertion opening may be either two separate airbag parts which are connected to one another outside the insertion opening, continuously along their outer edge using additional connecting means such as, for example, by sewing, weaving or bonding. On the other hand, the two airbag parts may also be a component of a single, planar airbag blank (fabric blank) which is preferably embodied so as to be symmetrical with respect to a mirror axis. In order to form the airbag sleeve, the airbag blank or fabric blank is folded around the mirror axis so that as a result two airbag parts (fabric layers) which rest one on the other are formed. These are connected to one another in one piece along the mirror axis and are attached to one another by additional connecting means, for example a seam or bonding agent, only at their other, adjacent edge regions. The insertion opening can be provided here on the one hand as an interruption in the edge region in which the two airbag parts are connected to one another in one piece or it can be provided in one of the edge regions in which the two airbag parts are connected to one another by additional connecting means.

In one variant of the invention, the two clips have at least one first mounting opening each, the mounting openings being embodied congruent with respect to one another in a spread out flat state of the airbag sleeve.

Furthermore, the two airbag parts have at least one second mounting opening each outside the clips, the mounting openings being embodied congruent with respect to one another in a spread out flat state of the airbag sleeve.

The one clip of one of the airbag parts is preferably placed over the other clip of the other airbag part in order to close the insertion opening, the at least one first mounting opening of the clip of one of the airbag parts coming to rest congruently on the at least one second mounting opening of the other airbag part so that a mounting element, in particular a bolt protruding from a gas generator, can engage through the two mounting openings in order to close the insertion opening.

### BRIEF DESCRIPTION OF THE DRAWINGS

Further details and advantages of the invention become clear in the subsequent description of exemplary embodiments with reference to the figures, in which:

FIG. 1a is a view of an airbag for an airbag module having an insertion opening for a gas generator, which opening can be closed by two clips arranged on the airbag;

FIG. 1b shows a cross section through the airbag from FIG. 1 in the region of the insertion opening.

FIG. 2 shows the airbag from FIGS. 1a and 1b during insertion of a gas generator;

FIG. 3 shows the airbag from FIG. 2 after the gas generator has been inserted and a clip placed around the gas generator;

FIG. 4a shows the airbag from FIG. 3 together with the inserted gas generator after the second clip has been placed around the gas generator;

FIG. 4b shows a cross section through the arrangement from FIG. 4a;

FIG. 5 shows an airbag according to FIG. 1a together with an electric connecting cable for connecting a gas generator;

FIG. 6 shows the airbag from FIG. 5 together with a gas generator inserted into the airbag;

FIG. 7a shows a refinement of the arrangement from FIG. 6;

FIG. 7b shows a cross section through the arrangement from FIG. 7a;

FIG. 8a shows an airbag blank in the form of an airbag panel which has been spread out flat and has the purpose of forming an airbag with an insertion opening;

FIG. 8b shows the airbag panel from FIG. 8a with a first clip which is arranged thereon and has the purpose of closing the insertion opening;

FIG. 8c shows the airbag panel from FIG. 8b with an additional second clip for closing the insertion opening;

FIG. 8d is a first view of the airbag panel from FIG. 8c after an airbag sleeve has been formed from it;

FIG. 8e is a second view of the airbag panel from FIG. 8c after an airbag sleeve has been formed from it;

FIG. 9a shows a refinement of the airbag panel from FIGS. 8a to 8c;

FIG. 9b is a first view of the airbag panel from FIG. 9a after an airbag sleeve has been formed from it;

FIG. 9c is a second view of the airbag panel from FIG. 9a after an airbag sleeve has been formed from it; and

FIG. 10 is a schematic sectional view of an airbag for an airbag module with an insertion opening for a tubular gas generator and clips which protrude from the insertion opening and which serves the purpose of closing the insertion opening.

### DETAILED DESCRIPTION

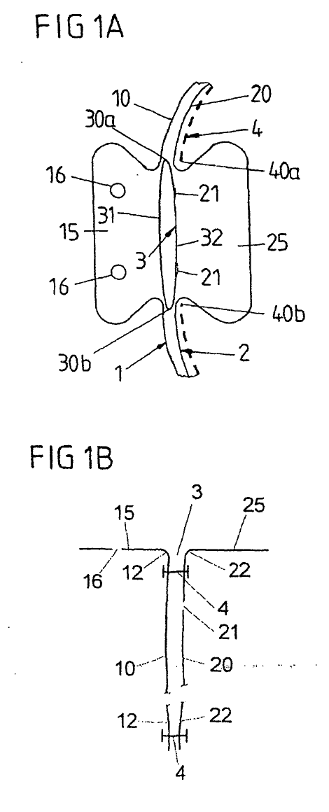

FIGS. 1a and 1b illustrate a detail of an airbag for an airbag module of a motor vehicle which can be filled with gas to form a gas cushion in the event of a crash in order to protect a vehicle occupant.

In order to arrange such an airbag in a motor vehicle, it is folded so that it can be accommodated as a compact airbag packet, for example on a steering wheel (in the case of a driver airbag) or behind a dashboard panel (in the case of a front seat passenger's airbag). Furthermore, an airbag of the type shown can be integrated, for example, in the folded state as a side airbag in a vehicle seat or a vehicle door, or it can be arranged as a head airbag behind the inner roof lining of a motor vehicle.

If an airbag which is folded together to form an airbag packet is filled with gas in the event of a crash, the airbag unfolds and emerges from the steering wheel or the dashboard in the direction of the passenger compartment of the corresponding motor vehicle where it then forms an air cushion in order to protect a vehicle occupant.

FIGS. 1a and 1b show the airbag in the unfolded state, that is to say before it is folded up to form an airbag packet to be placed in a motor vehicle. According to FIGS. 1a and 1b, the airbag is formed by two airbag parts 1, 2 which are each in the form of a fabric layer 10 and 20, respectively, which are connected to one another along their respective outer edge by a seam 4. Instead of the formation of a seam 4 to connect the two airbag parts 1, 2 in the form of fabric layers 10, 20, it is also possible to use other connecting techniques such as, for example, bonding or riveting. In addition, the airbag parts 1, 2 do not necessarily need to be fabric layers 10, 20. All that is important is that the two airbag parts 1, 2 are each formed by a flexible, planar part (i.e. a flexible airbag layer) which can be connected to one another along their respective edge in such a way that they surround an interior which can be filled with gas, that is to say form an airbag sleeve which can be filled with gas and in the process can take on the shape of an air cushion in order to protect a vehicle occupant.

From FIGS. 1a and 1b it is also clear that the seam 4 by means of which the two airbag parts 1, 2 are connected to one another in the form of fabric layers 10, 20 has an interruption along which an insertion opening 3 is formed between the airbag parts 1, 2, through which insertion opening 3 an assembly which is to be arranged in the interior of the airbag, for example a gas generator, can be inserted into the interior of the airbag. The insertion opening 3 extends in the manner of a slit between a first end 30a and a second end 30b which each coincide with one of the two points 40a, 40b at which the connecting seam 4 of the two airbag parts 1, 2 is interrupted. In other words, the connecting seam 4 which runs around along the edge of the two airbag parts 1, 2 has two free ends 40a, 40b so that the seam 4 forms an open ring and is interrupted between the two free ends 40a, 40b. In the region between the two free ends 40a, 40b of the seam 4, the two airbag parts 1, 2 are not connected to one another so that here a slit-shaped insertion opening 3 is produced, said insertion opening 3 extending between a first end 30a and a second end 30b and being bordered on each of its two longitudinal sides by an edge section 31 and 32, respectively, which are embodied so as to be mirror symmetrical to one another. Here, one 31 of the edge sections forms a component of the first airbag part 1 or of the corresponding fabric layer 10, and the second edge section 32, lying opposite, forms a component of the other airbag part 2 or of the corresponding fabric layer 20.

A clip 15 or 25 is formed in one piece onto the associated airbag part 1 and 2, that is to say is woven here onto the respective fabric layer 10 or 20, along each of the two edge sections 31, 32 of the insertion opening 3, said fabric layer 10 or 20 protruding from the edge 12 or 22 of the corresponding airbag part 1 or 2. Each of the two clips 15, 25 extend essentially along the entire associated edge section 31 or 32 so that the insertion opening 3 can be covered by each of the two clips 15, 25, of trapezoidal shape here, over its entire length between the two ends 30a, 30b. A shorter side of the respective trapezoidal clip 15, 25 forms here the associated edge section 31 or 32 of the insertion opening 3, and a longer side, lying opposite, of the respective trapezoidal clip 15, 25 faces the insertion opening 3.

In addition, in each case two mounting openings 16 and 21, respectively, are formed in the clip 15 of one airbag part 1 and in the other airbag part 2 outside the clip 25, said mounting openings 16 and 21 serving to attach a gas generator which is to be arranged inside the airbag.

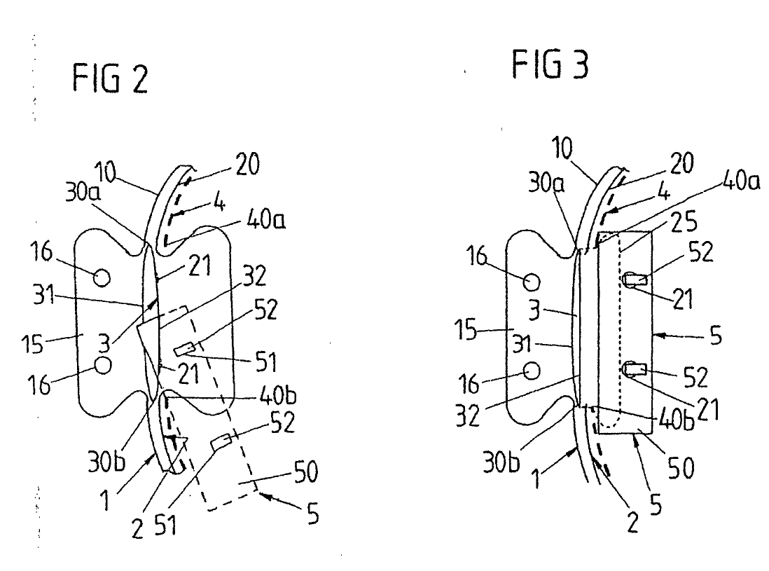

FIG. 2 shows the airbag from FIG. 1 together with a gas generator 5 which is introduced through the insertion opening 3 in the form of an insertion slit into the interior of the airbag which is formed between the two airbag parts 1, 2 or between the corresponding fabric layers 10, 20. The gas generator 5 here is in the form of a tubular gas generator from whose outer lateral surface 50 two mounting elements 51 which are spaced apart (essentially radially) from one another (in the direction of the longitudinal extent of the tubular gas generator 5) protrude with a widened section 52 in the form of a collar, said collars being provided to engage in the mounting openings 16, 21 of the airbag.

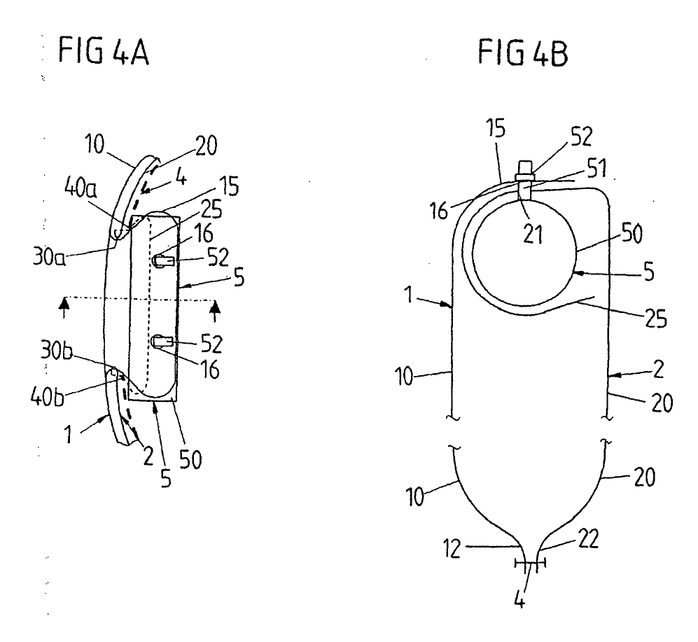

After the insertion of the gas generator 2 through the insertion opening 3 into the interior of the airbag between the two airbag parts 1, 2, according to FIG. 3 the gas generator 5 is placed within the airbag by inserting the two mounting bolts 51 of the gas generator 5 into in each case one of the two mounting openings 21 of the second airbag part 2, the distance between the mounting openings 21 corresponding to the distance between the mounting bolts 51. The widened portions 52 of the mounting bolts 51 are pushed through here by stretching the respective edge of the mounting openings 21 so that the mounting bolts 51 subsequently engage with their respective widened portion 52 in the form of a collar behind the edge of the associated mounting opening 21 on the airbag side. This results in a positively locking connection between the gas generator 5 and the second airbag part 2 or the corresponding fabric layer 20. Then, as is already apparent from FIG. 3, the clip 25 which is provided on the second airbag part 2 which is provided with the mounting openings 21—said clip 25 not having any mounting openings itself—is led through the insertion opening 3 into the interior of the airbag and placed or folded around the lateral face 50 of the gas generator 5 there so that it at least partially engages around the gas generator 5 (along its lateral face 50).

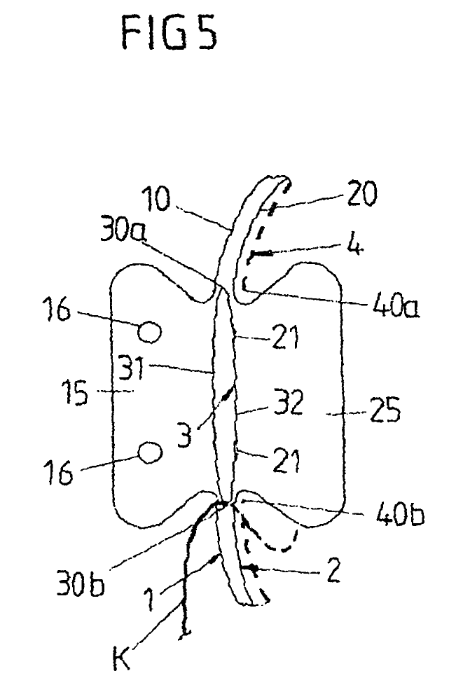

Then, according to FIGS. 4a and 4b, the first clip 15 which is provided with two mounting openings 16 and is provided on the first airbag part 1, not provided with mounting openings outside the clip 15, or the corresponding fabric layer 10, is laid on the outside of the airbag or of the airbag sleeve formed by the airbag parts 1, 2 via the insertion opening 3, and in the process positioned simultaneously around the gas generator 5 or its lateral face 50. The first clip 1 is fixed in this position by virtue of the fact that the two mounting bolts 51 which are provided on the gas generator are inserted into the mounting openings 16, provided for this purpose, on the first clip 15 until the widened section 52 (collar) of a respective mounting bolt 51 engaged behind the edge of the associated mounting opening 16 on the first clip 1 in such a way that a positively locking connection is formed between the first clip 1 and the gas generator 5 or its mounting bolt 51. Then, as becomes clear from FIGS. 4a and 4b, the gas generator 5 is arranged and placed in a defined fashion in the interior of the airbag and in the process is connected to the two airbag parts 1, 2 (via its mounting bolts 51), specifically to the first airbag part 1 through engagement of the mounting bolts in associated mounting openings 16 in the clip 15 which is provided on the first airbag part 1, and on the second airbag part 2 through direct engagement in mounting openings 21 which are provided outside the associated second clip 25.

The fact that here the first airbag part 1 outside its clip 15 and the clip 25 which is provided on the second airbag part 2 do not have any mounting openings means that the function of the illustrated airbag arrangement does not require such openings. However, in order to provide easily handled identical parts it is also possible to provide additional mounting openings without a function, for example on the clips 25 of the second airbag part 2.

The two clips 15, 25 of the airbag which engage around the gas generator 5 and are each provided on one of the two airbag parts 1, 2, close the insertion opening 3, in the end state (shown in FIGS. 4a and 4b) which is secured by the connection to the gas generator 5 (by means of its mounting bolt 51), so that said insertion opening 3 is covered in an essentially gas-tight fashion by the clips 15, 25 which overlap (at least along the insertion opening 3), one clip 15 of which extends on the outside of the airbag and the other clip 25 of which extends in the interior of the airbag. For this purpose, there is no need for any separate additional elements which are provided especially for closing the insertion opening 3 but rather this is done by means of clips 15, 25 which are formed in one piece with the airbag parts 1, 2 and on mounting openings 16, 21 which are provided in the airbag parts 1, 2 or the clips 15, 25 as well as assigned mounting bolts 51 which are arranged on the gas generator 5. The arrangement which is illustrated in FIGS. 1a to 4b is thus distinguished not only by the possibility of simply mounting and positioning the gas generator 5 in the interior of the airbag but also by being able to simply and reliably close the insertion opening 3 of the airbag which is provided for this purpose.

Of course, instead of the mounting bolts on the gas generator 5 it is also possible to provide other connecting means by means of which the gas generator can be connected to the airbag parts 1, 2 or their clips 15, 25.

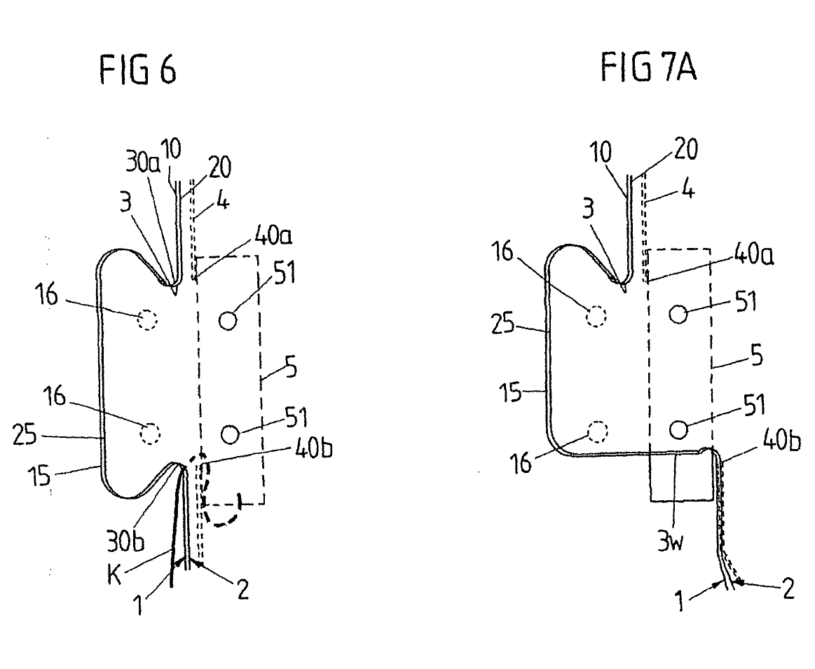

As will also be explained by way of example below with reference to FIGS. 5 to 7b, the configuration of the insertion opening, of the clips protruding from the edge sections of the insertion opening and their distance and position can be varied as a function of the respective purpose of use. In particular, the configuration of the clips with respect to the insertion opening can be such that after the insertion opening has been closed by the clips a partial opening still remains clear, through which partial opening mounting parts, such as for example a connecting cable which is provided for electrically connecting the gas generator or a section of the gas generator itself can protrude out of the interior of the airbag. The partial opening of the insertion opening which is not covered by the clips is preferably dimensioned here in such a way that it is closed by the mounting part which engages through it.

According to FIG. 5, which is a view of an airbag according to FIG. 1a, a connecting cable K leads into the interior of the airbag at one end 30b of the insertion opening 3 between the two edge sections 31, 32 of said insertion opening 3, so that a gas generator which is inserted into the interior of the airbag, or the electrical firing mechanism of said gas generator, can be connected to the onboard electrical system of the vehicle via the connecting cable K.

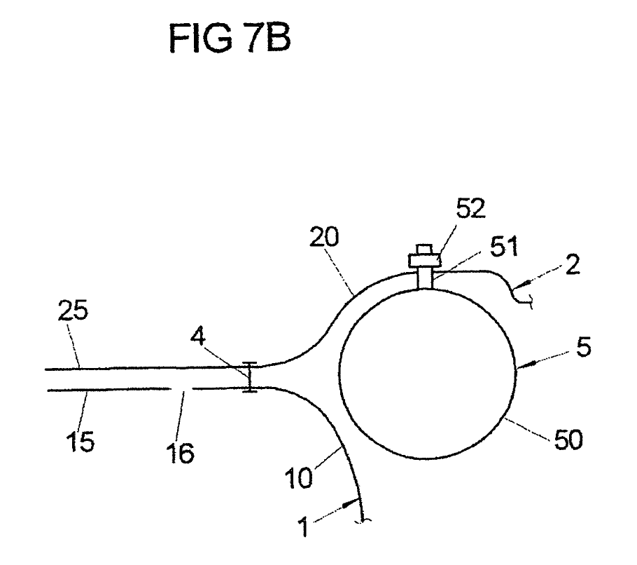

FIG. 6 shows the arrangement from FIG. 5 after the insertion of a gas generator 5 into the interior of the airbag and after the second clip 25 has been placed on the first clip 15 of the airbag, before the second clip 25 is moved out of this position and into the interior of the airbag and in the process placed around the gas generator 5 (cf. FIG. 3).

It is apparent that after the insertion opening 3 has been finally closed by folding over the first clip 15 on the outside of the airbag by means of the gas generator 5, as is illustrated by reference to FIGS. 4a and 4b, the insertion opening 3 of the airbag is also essentially closed in the exemplary embodiment illustrated in FIGS. 5 and 6, but the electric connecting cable K leads to the outside from the interior of the airbag (where it is electrically connected to the gas generator 5 or its firing mechanism) through a correspondingly small passage at one end 30b of the insertion opening 3. This passage of the insertion opening 3 is in turn closed by the connecting cable K which engages through it.

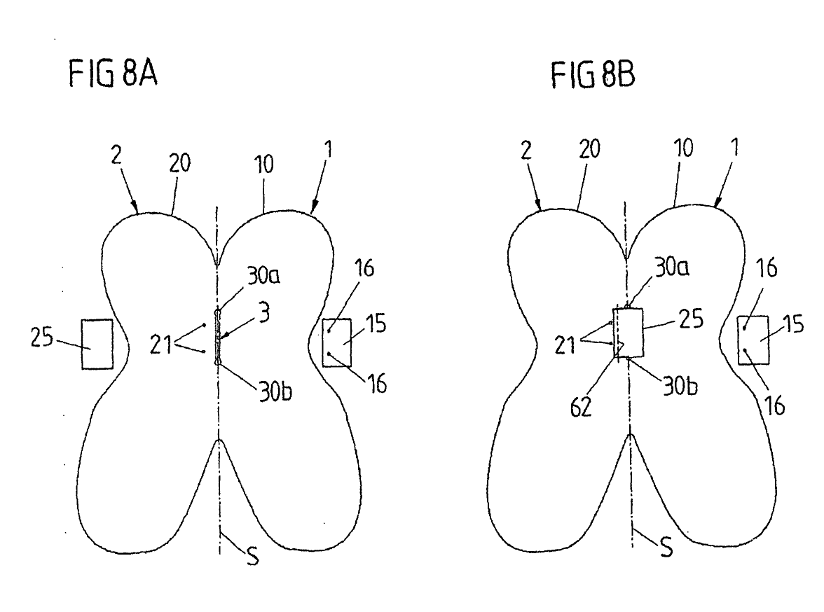

FIGS. 7a and 7b show a refinement of the airbag from FIGS. 1a to 6 in an illustration corresponding to FIG. 6, in which refinement the edge sections of the two airbag parts 1, 2 which bound the insertion opening 3 and the clips 15, 25 which protrude from said edge sections are configured in such a way that the insertion opening 3 which is formed between the two free ends 40a, 40b of the connection seam 4 of the two airbag parts 1, 2 has a bent section 3b which is not closed when the two clips 15, 25 are folded over, as illustrated in FIGS. 3, 4a and 4b. For this reason the gas generator 5 which is arranged in the interior of the airbag can protrude with an end section from said airbag through this bent partial opening 3w so that electrical contact between the gas generator 5 and an assigned connecting cable is possible outside the airbag.

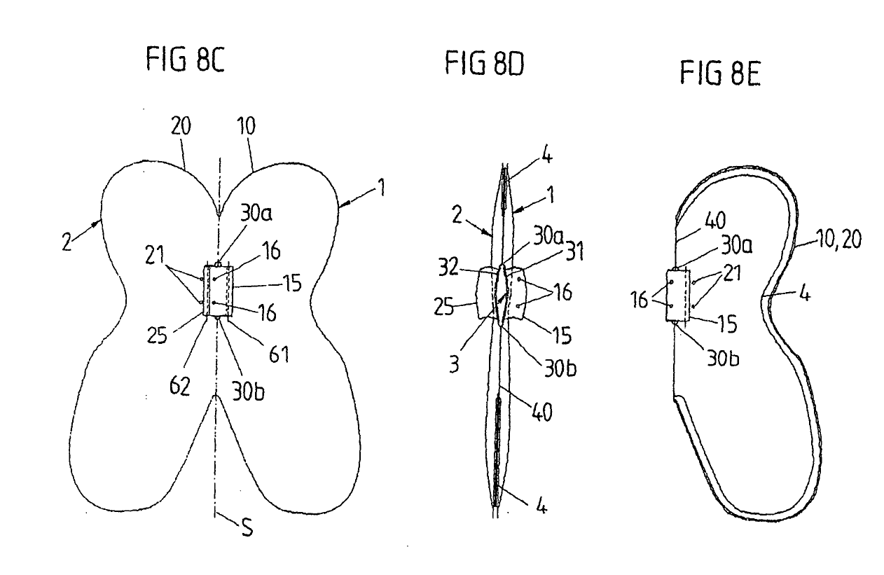

FIGS. 8a to 8e illustrate a plurality of steps during the formation of a further airbag of the type shown in FIGS. 1a to 4b, an essential difference being that in the airbag described with reference to FIGS. 8a to 8e the two airbag parts 1, 2 are single-piece components of an airbag panel.

This becomes clear in FIG. 8a in which the two airbag parts 1, 2 (formed by fabric layers 10, 20) are illustrated as components of an airbag blank in the form of a single planar airbag panel (fabric panel). The airbag panel which forms the two planar airbag parts 1, 2 in the form of one fabric layer 10, 20 each is embodied mirror symmetrically with respect to a mirror axis S so that on each side of the mirror axis S each of the two airbag parts 1, 2 has an outer edge which can be made to overlap the edge of the respective other of the two airbag parts 1, 2 if the two airbag parts 1, 2 are folded about the mirror axis S as a folding axis and placed one on top of the other.

The region which extends along the mirror axis S and along which the two airbag parts 1, 2 or the corresponding fabric layers 10, 20 are connected to one another in one piece so that they form a single fabric has a slit-shaped interruption which extends longitudinally along the mirror axis S and which forms an insertion opening 3, extending between two ends 30a, 30b, for a gas generator, as described with reference to FIGS. 1a to 4b. The difference between the insertion opening according to FIG. 8a and the insertion opening described with reference to FIGS. 1a to 4b is that according to FIG. 8a the insertion opening 3 is formed as an interruption in a region in which the two airbag parts 1, 2 are connected to one another in one piece, that is to say without the use of additional connecting means, while according to FIGS. 1a to 4b the insertion opening illustrated there is formed by the connection formed by separate connecting means in the form of a seam between two airbag parts being interrupted.

In addition, in FIG. 8a it is clear that one of the two airbag parts 1, 2 is provided with two mounting openings 21 which serve to secure the corresponding airbag part 2 to a gas generator (as is described above with reference to FIGS. 1a to 4b. Furthermore, FIG. 8a illustrates two clips 15, 25 (fabric clips) which are composed of fabric and which serve to cover and close the insertion opening 3 after the insertion of a gas generator into the interior of the airbag. In contrast to the exemplary embodiment described with reference to FIGS. 1a to 4b, the two clips 15, 25 here are not woven in one piece onto in each case one of the two airbag parts 1, 2 in the form of a fabric layer 10 or 20, but instead they are attached thereto as separate components, as will be described below with reference to FIGS. 8b and 8c.

There is correspondence with the exemplary embodiment shown in FIGS. 1a to 4b to the extent that one of the two clips which is to be arranged on the airbag part 1 which is not provided with mounting openings has two mounting openings 16, while the other clip 25 which is to be arranged on the airbag part 2 which is provided with mounting openings 21 does not have any mounting openings. For reasons of the use of identical parts it would however be possible to provide, for example, the second clip 25 likewise with mounting openings but these would then be without function in the present exemplary embodiment.

FIG. 8b shows the airbag panel which forms two airbag parts 1, 2 after the clip 25 which does not have any mounting openings has been attached by means of a seam 62 to the fabric layer 20 having mounting openings 21, in such a way that said clip 25 lies flat over the insertion opening 3 and covers it between the two ends 30a, 30b.

FIG. 8c shows the airbag panel which forms two airbag parts 1, 2 from FIG. 8b, according to which the clip 15 which has two mounting openings 16 has been additionally attached by means of a seam 61 to the fabric layer 10 which does not have any mounting openings, specifically attached in such a way that it both rests on the clip 25 which has been previously attached and at the same time together with said clip 25 covers the insertion opening 3.

The two airbag parts 1, 2 and the corresponding fabric layers 10, 20 are subsequently folded around the mirror axis S as a folding axis in such a way that they bear with their outer edge against one another and at the same time the two clips 15, 25 are located on the outside of the sleeve of the airbag which is formed by the airbag parts 1, 2 or the fabric layers 10, 20, as illustrated in two different views in FIGS. 8d and 8e.

In order to form an airbag sleeve which is closed except for the insertion opening 3, the two airbag parts 1, 2 and the fabric layers 10, 20 are connected to one another by suitable connecting means 4, in the form of a seam, in the edge regions in which they are not connected to one another in one piece (as a single fabric panel). As has already been explained, it is not necessary to sew the two airbag parts 1, 2 or the fabric layers 10, 20 to one another on each side of the ends 30a, 30b of the insertion opening 3 since said airbag parts 1, 2 or fabric layers 10, 20 are woven to one another in one piece there by means of a connecting region 40, to be precise form components of a single airbag panel or fabric panel.

As a result, the airbag illustrated in FIGS. 8d and 8e corresponds—with the exception of the single-piece embodiment of the two fabric parts 1, 2, on the one hand, and the fact that, on the other hand, the two clips 15, 25 are embodied separately from these—to the airbag of which a detail is illustrated in FIGS. 1a and 1b. Therefore, with respect to the insertion and the arrangement of a gas generator in the airbag shown in FIGS. 8d and 8e, reference is therefore made to the above statements relating to FIGS. 1a to 4b.

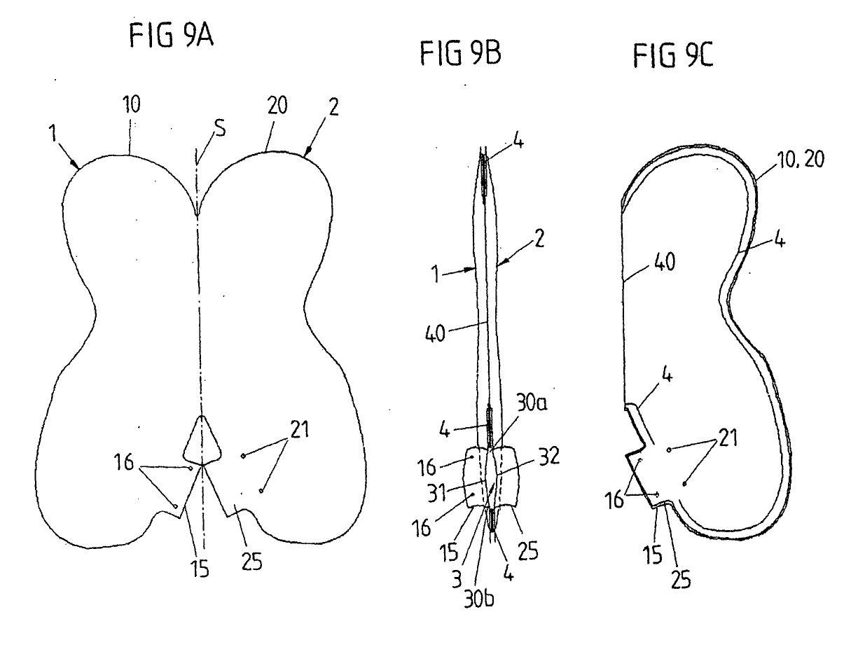

FIG. 9a illustrates a refinement of the airbag blank in the form of an airbag panel from FIG. 8a, which in turn forms two airbag parts 1, 2 or fabric layers 10, 20 which are embodied symmetrically with respect to a mirror axis S, but the two clips 15, 25 are also woven in one piece to the respective airbag part 1, 2 in the form of a fabric layer 10, 20. A further difference is that here, as becomes clear in particular from FIGS. 9b and 9c, the insertion opening 30 of the airbag which is to be formed from the airbag part 1, 2 is to be provided in an edge section of the airbag, which edge section lies outside the connecting region in which the two airbag parts 1, 2 are woven to one another in one piece. Correspondingly, the two clips 15, 25 protrude from the respective airbag part 1, 2 in a region in whose direct vicinity the two airbag parts 1, 2 are not connected to one another in one piece.

FIGS. 9b and 9c show the airbag formed from the airbag panel or fabric panel according to FIG. 9a. The fabric panel is produced by virtue of the fact that the two airbag parts 1, 2 are placed one on top of the other by folding over around the axis S of symmetry in such a way that their outer edges rest one on the other congruently. The two airbag parts 1, 2 or the fabric layers 10, 20 are then connected to one another along their circumferential outer edge by means of a seam 4—outside the connecting region 40 in which the two fabric layers 10, 20 are woven to one another in one piece—but the seam 4 is interrupted between the two clips 15, 25 so that an insertion opening 3 which extends between two ends 30a, 30b is formed there for a gas generator, the one clip 15, provided with mounting openings 16, protruding from one lateral edge 31 of said insertion opening 3 and the other clip 25 which is not provided with insertion openings protruding from the other lateral edge 32 of said insertion opening 3.

With respect to the use of the insertion opening 3 for inserting a gas generator into the interior of the airbag and the subsequent covering and closing of the insertion opening, the inserted gas generator being placed in a defined fashion within the airbag by means of mounting openings 16 on a clip 15 and mounting openings 21 on an airbag part 2 reference should be made to the above statements relating to FIGS. 1a to 4b.

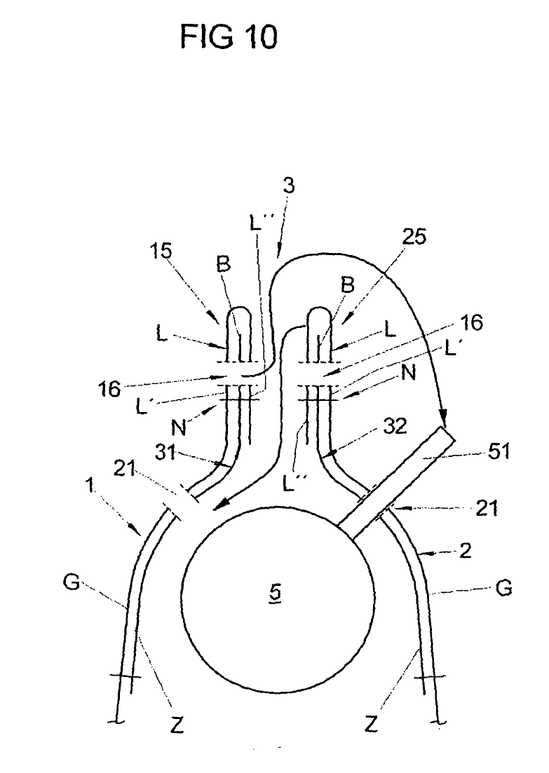

FIG. 10 shows a schematic sectional view through an airbag which is spread out flat along a plane, the sectional plane being perpendicular to the plane along which the airbag is spread out.

The airbag has an airbag sleeve which surrounds an interior of the airbag and which is formed by two airbag parts 1, 2 which are connected to one another along their circumferences and each have a first fabric layer G with an inner side facing the interior of the airbag sleeve and an outer side which faces away from the interior and is turned toward the outside.

The two first fabric layers G are embodied congruent with respect to one another in a spread out flat state (free of folds), i.e. they have an identical shape (outline contour) and area.

The connection of the two airbag parts 1, 2 (or fabric layers G) is interrupted along two edge sections 31, 32 of the two airbag parts 1, 2 so that an insertion opening 3 is formed through which a cylindrical gas generator 5 is inserted into the interior of the airbag.

A clip 15, 25 which serves to close the insertion opening 3 and which is formed in each case by a flexible material section L protrudes from each of the two edge sections 31, 32, said material section L protruding from the respective first fabric layer G and being connected in one piece to it, as well as by a material region B of a second fabric layer Z which is arranged in the region of the gas generator 5, in each case in front of the inner side of the first fabric layer G in the interior of the airbag sleeve.

Here, the material section L of a respective clip 15, 25 engages around the material region B of the respective clip 15, 25 so that the clips 15, 25 are each embodied in three layers. That is to say the material region L of the respective clip 15, 25 which protrudes in each case from a first fabric layer G—with respect to a spread out flat state—and in the process projects over the assigned material region B of a second fabric layer Z with a section L″, is folded with this section L″ onto the material region B of the respective clip 15, 25 so that in each case a three-layer clip 15, 25 composed of two sections L′, L″ of the material section L is formed, said sections L′, L″ being arranged on each side of the respective material region B. In order to secure this folded state, the respective material section L is connected to the respectively assigned material region B by means of a seam N. The seam N connects the two sections L′, L″ to the intermediately located material region B of the respective clip 15, 25.

The two second fabric layers Z are also preferably embodied congruent with respect to one another—with respect to a spread out flat state—as are the two clips 15, 25 which are also embodied mirror symmetrically to one another in the spread out flat state of the airbag sleeve.

The present airbag blank is distinguished by a particularly high degree of symmetry, which advantageously simplifies the manufacture of the airbag. For this reason, both the two clips 15, 25 and the two airbag parts 1, 2 each have first and second mounting openings 16, 21 which come to rest congruently one on top of the other in a spread out flat state of the airbag sleeve. These mounting openings 16, 21 of the clips 15, 25 and airbag parts 1, 2 are formed by cutouts in the first and second fabric layers G, Z, which are each formed (for example punched) congruently on the fabric layers, i.e. if the two first fabric layers G are spread out flat and placed congruently one on top of the other, the cutouts which form the first and the second mounting openings 16, 21 in the connected state of the first and second fabric layers G, Z come to rest congruently one on top of the other. The same applies to the second fabric layers Z.

Since the second mounting openings 21 are formed on the other side of the clips 15, 25, and the first mounting openings 16 which are formed on the clips 15, 25 are formed in regions of the airbag parts 1, 2 in which said airbag parts 1, 2 are embodied at least in two layers—in these regions the first and second fabric layers G, Z rest one on top of the other in each case—the second mounting openings 21 are formed on the other side of the clips 15, 25 in each case by means of a cutout in the first fabric layer G and a cutout in the second fabric layer Z resting thereon.

In the case of the clips 15, 25 which are embodied in three layers, the first mounting openings 16 are formed in each case by two cutouts in the material section L and one cutout in the material region B, said cutouts being arranged congruently one over the other in the folded state of the respective material section L.

In each case at least one second mounting opening 21 which is formed on an airbag part 2 and at least one first mounting opening 16 which is formed on a clip 15 of the respective other airbag part 1 are required to secure the gas generator 5 with respect to the airbag and to close the insertion opening 3. The other mounting openings 16, 21 on the other clip 25 and on the other airbag part 1 are not required and are merely present for reasons of symmetry, i.e. the two airbag parts 1, 2 are to form identical components in order to simplify the manufacture of the airbag.

The gas generator 5 is first introduced through the insertion opening 3 into the airbag sleeve and arranged there in the interior of the airbag sleeve in such a way that a mounting element 51 in the form of a bolt which protrudes from the gas generator 5 projects out of the interior of the airbag sleeve through the second mounting opening 21 of the one airbag part 2. Then, the clip 25 which is associated with the one airbag part 2 is arranged in the interior of the airbag sleeve through the insertion opening 3, specifically in such a way that it comes to rest between the gas generator 5 and the other airbag part 1, while partially engaging around the gas generator 5. The clip 15 of the other airbag part 1 is then placed over the insertion opening 3 (and the clip 25), the bolt 51 being fed through the first mounting opening 16 of the clip 15 of the other airbag part 1. The clip 15 of the other airbag part 1 is preferably secured to the bolt 51 by means of a nut. This both securely closes the insertion opening 3 and fixes the gas generator 5 with respect to the airbag sleeve.

What is claimed is:

1. An airbag for a motor vehicle airbag module, comprising:
an airbag sleeve which surrounds an interior of the airbag which can be filled with gas and which is formed by at least two airbag parts which are connected to one another, and an insertion opening of the airbag sleeve formed by an interruption of the connection between the two airbag parts so that the two airbag parts each form one edge section of the insertion opening;
a pair of clips, each of the clips protruding from one of the two edge sections of the insertion opening;
wherein each of the two clips are formed from at least one flexible material section, and wherein the at least one material section of the one clip being embodied congruent with respect to the at least one material section of the other clip in a spread out flat state.

2. The airbag of claim 1, wherein each of the two airbag parts comprise a first fabric layer and wherein each of the clips are integrally formed with one of the first fabric layers.

3. The airbag of claim 2, wherein each of the first fabric layers are congruent in a spread out flat state.

4. The airbag of claim 3, wherein the airbag parts each include a second fabric layer which bears in each case in front of an inner side of a first fabric layer which faces the interior of the airbag sleeve.

5. The airbag of claim 4, wherein the second fabric layers are congruent in a spread out flat state.

6. The airbag of claim 5, wherein the clip assigned to the respective airbag part is formed by part of one of the second fabric layers.

7. An airbag module for a motor vehicle airbag module, comprising:
an airbag including an airbag sleeve which surrounds an interior of the airbag which can be filled with gas and which is formed by at least two airbag parts which are connected to one another, and an insertion opening of the airbag sleeve formed by an interruption of the connection between the two airbag parts so that the two airbag parts each form one edge section of the insertion opening;
a pair of clips, each of the clips protruding from one of the two edge sections of the insertion opening;
wherein each of the two clips are formed from at least one flexible material section, and wherein the at least one material section of the one clip being embodied congruent with respect to the at least one material section of the other clip in a spread out flat state;
a gas generator located in the interior of the airbag and can be inserted into the airbag through the insertion opening.

8. The airbag module of claim 7, wherein the clips are laid around the gas generator in such a way that they at least partially engage around the gas generator, and in that the two clips overlap.

9. The airbag module of claim 8, wherein in an overlapping region of the two clips the one clip at least partially covers the other clip so that the other clip extends between the one clip and the gas generator.

10. The airbag module of claim 9, wherein a mounting element which engages through a mounting opening of the clip protrudes from the gas generator in order to secure the at least one clip to the assembly.

11. The airbag module of claim 10, wherein one clip covers the insertion opening on the outside of the airbag sleeve facing away from the interior of the airbag.

12. The airbag module of claim 7, wherein another clip is led into the interior of the airbag through the insertion opening and extends on the inside of the airbag sleeve, in front of the insertion opening.

13. The airbag module of claim 7, wherein each of the clips extends essentially along the entire assigned edge section of the insertion opening so that the edge of the insertion opening is bounded essentially completely by the clips.

14. The airbag module of claim 7, wherein the insertion opening is essentially closed off by the clips which cover one another.

15. The airbag module of claim 7, wherein the insertion opening is closed off by the clips except for a passage for an electric connecting cable.

16. The airbag module of claim 7, wherein the insertion opening is closed off by the overlapping clips except for a partial opening through which the gas generator partially projects out of the interior of the airbag.

17. The airbag module of claim 7, wherein the edge sections of the insertion opening are arranged and positioned to symmetrically mirror one another.

18. The airbag module of claim 7, wherein each of the clips is formed in one piece woven structure with the associated airbag part.

19. The airbag module claim 7, wherein the airbag parts are connected to one another outside the insertion opening.

20. The airbag module of claim 19, wherein the airbag parts are connected to one another outside the insertion opening, at least in certain sections, by sewing, bonding or riveting.

21. The airbag module of claim 7, wherein the two clips have at least one first mounting opening each, the mounting openings being embodied congruent with respect to one another in a spread out flat state of the airbag sleeve.

22. The airbag module of claim 7, wherein the two airbag parts have at least one second mounting opening each outside the clips, the mounting openings being embodied congruent with respect to one another in a spread out flat state of the airbag sleeve.
